(19) United States
(12) Patent Application Publication
(10) Pub. No.: US 2016/0137168 A1
(43) Pub. Date: May 19, 2016

(54) WINDSCREEN WIPER DEVICE

(71) Applicant: FEDERAL-MOGUL S.A., Aubange (BE)

(72) Inventor: THOMAS FRISCIONI, MEXY (FR)

(21) Appl. No.: 14/905,037

(22) PCT Filed: Jul. 22, 2013
(86) PCT No.: PCT/EP2013/065443

§ 371 Date: Jan. 14, 2016

(51) Int. Cl. B60S 1/34; B60S 1/52; B60S 1/38

(52) U.S. Cl. CPC B60S 1/3415; B60S 1/38; B60S 1/3481; B60S 1/52

(57) ABSTRACT

A windscreen wiper device, particularly for automobiles, comprises an elongated wiper blade of a flexible material, which can be placed in abutment with a windscreen to be wiped. The wiper blade comprising includes a connecting device for an oscillating arm, wherein the oscillating arm near one end thereof is pivotally connected to the wiper blade and near the other end thereof is connected to a mounting head on a drive shaft for transferring a reciprocal movement to the wiper blade. A cap is connected to the mounting head at the location where the oscillating arm is connected to the mounting head. The drive shaft is arranged to spray a liquid under pressure through an opening of the cap onto a windscreen to be wiped. The drive shaft is arranged to spray the liquid in axial direction thereof onto an internal guiding surface of the cap in order to guide the liquid along the guiding surface through the opening of the cap onto a windscreen to be wiped.

### BACKGROUND OF THE INVENTION

1. Technical Field

The present invention relates to a windscreen wiper device, particularly for automobiles, comprising an elongated wiper blade of a flexible material, which can be placed in abutment with a windscreen to be wiped, the wiper blade comprising a connecting device for an oscillating arm, wherein the oscillating arm near one end thereof is pivotally connected to the wiper blade and near the other end thereof is connected to a mounting head on a drive shaft for transferring a reciprocal movement to the wiper blade, wherein the windscreen wiper device further comprises a cap connected to the mounting head at the location where the oscillating arm is connected to the mounting head, wherein the drive shaft is arranged to spray a liquid under pressure through an opening of the cap onto a windscreen to be wiped.

2. Related Art

Such a windscreen wiper device is generally known. In the known windscreen wiper device in a midway position of the wiper blade the drive shaft is arranged to spray a jet of washing liquid laterally outwardly through the opening of the cap onto a windscreen to be wiped. As the washing liquid is sprayed onto the windscreen to be wiped in a position of the wiper blade halfway its oscillatory movement, the washing liquid is not able to cover the entire windscreen to be wiped, so that the windscreen cannot be sufficiently cleaned, if needed. the opening in the cap is required to be sufficiently large to enable the washing liquid to reach the windscreen to be wiped, resulting in a less attractive design thereof. As the washing liquid is sprayed laterally outwardly relative to the drive shaft, the cap needs to have a sufficient height so to allow the washing liquid to reach the windscreen to be wiped, the height negatively influences the visibility from the drivers point of view, while it may give rise to damages in a car wash installation.

It is an object of the invention to obviate these disadvantages in the sense that at minimum costs—without using complex machinery and additional tools—a compact windscreen wiper device is proposed for efficiently cleaning a windscreen to be wiped.

It is noted that the present invention is not restricted to cars, but also refers to rail coaches and other (fast) vehicles.

In order to accomplish that objective a windscreen wiper device mentioned in the preamble is characterized in that the drive shaft is arranged to spray the liquid in axial direction thereof onto an internal guiding surface of the cap in order to guide the liquid along the guiding surface through the opening of the cap onto a windscreen to be wiped. In other words, the cap and the drive shaft cooperate together so as to allow the fluid exiting the drive shaft in an axial direction thereof and subsequently hitting the guiding surface of the cap, to go through the opening of the cap and cover the windscreen to be wiped.

In a preferred embodiment of a windscreen wiper device in accordance with the invention the guiding surface is part of top surface of the cap.

In a further preferred embodiment of a windscreen wiper device according to the invention the top surface has a curved shape so as to allow the liquid to exit the opening of the cap under an angle a with the drive shaft towards a windshield to be wiped. Particularly, an end portion of the curved shape encloses an angle a with the drive shaft. More in particular, the angle a is lying with the range of 10-30°.

In a further preferred embodiment of a windscreen wiper device in accordance with the invention the guiding surface is part of side surface of the cap.

In a further preferred embodiment of a windscreen wiper device according to the invention the side surface has a curved shape so as to allow the liquid to exit the opening of the cap under an angle β with the drive shaft and parallel to the wiper blade. In particular, an end portion of the curved shape encloses an angle 1 with the drive shaft. Preferably, the angle β is lying with the range of 10-30^{°}.

The present windscreen wiper device is preferably arranged to be used on a rear windscreen.

The present invention also relates to a drive shaft to be used and as defined in a windshield wiper device in accordance with the invention.

The present invention also refers to a cap to be used and as defined in a windshield wiper device according to the invention.

Particularly, the windscreen wiper device in accordance with the invention comprises an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, wherein ends of the longitudinal strip are connected with a respective connecting piece, which windscreen wiper device comprises a connecting device for an oscillating arm. Such a windscreen wiper device is thus designed as a “yokeless” wiper device or “flat blade”, wherein use is no longer made of several yokes pivotally connected to each other, but wherein the wiper blade is biased by the carrier element, as a result of which it exhibits a specific curvature. It is noted that the present invention is not restricted to such a “flat blade”, although being advantageous therein, but also extends to other types of windscreen wiper devices, such as the ones with yokes as referred to above.

THE DRAWINGS

The invention will now be explained in more detail with reference to figures illustrated in a drawing, wherein:

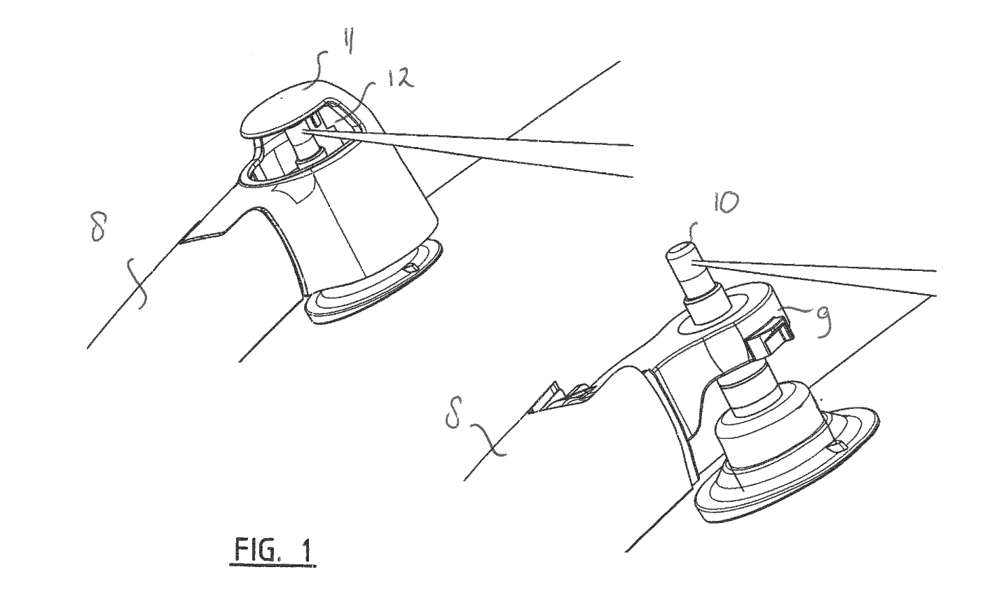

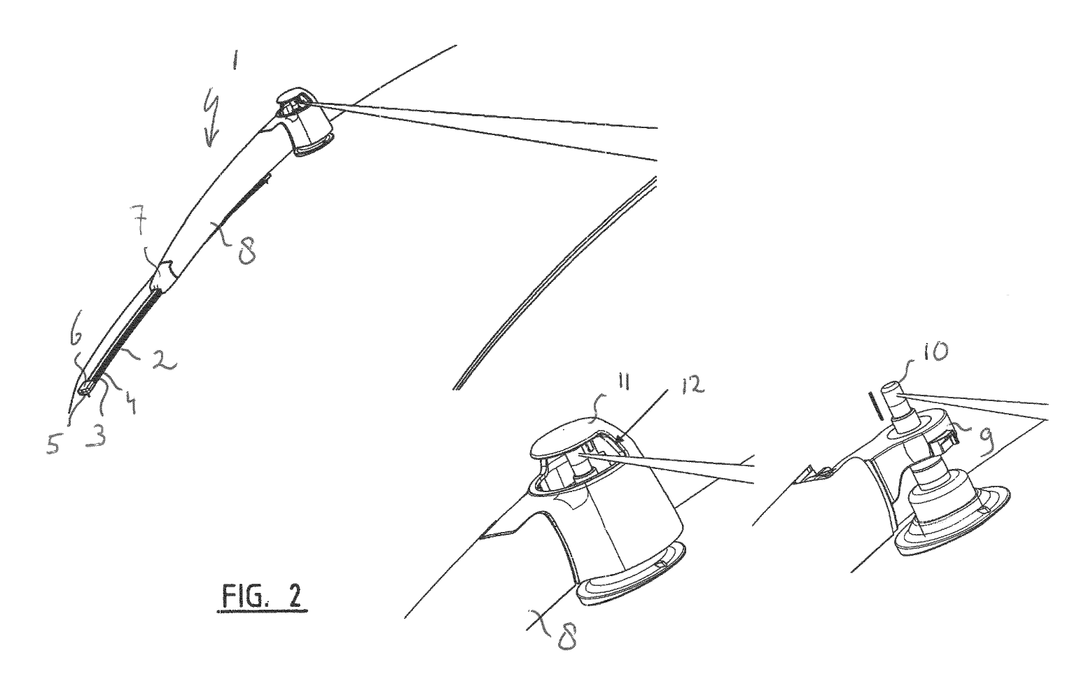

FIGS. 1 and 2 are perspective and schematic views of (details of) a prior art windscreen wiper device, wherein an oscillating arm near one end thereof is pivotally connected to a wiper blade and near the other end thereof is connected to a mounting head on a drive shaft for transferring a reciprocal movement to the wiper blade, and wherein the drive shaft is arranged to spray a liquid jet directly onto a windscreen to be wiped;

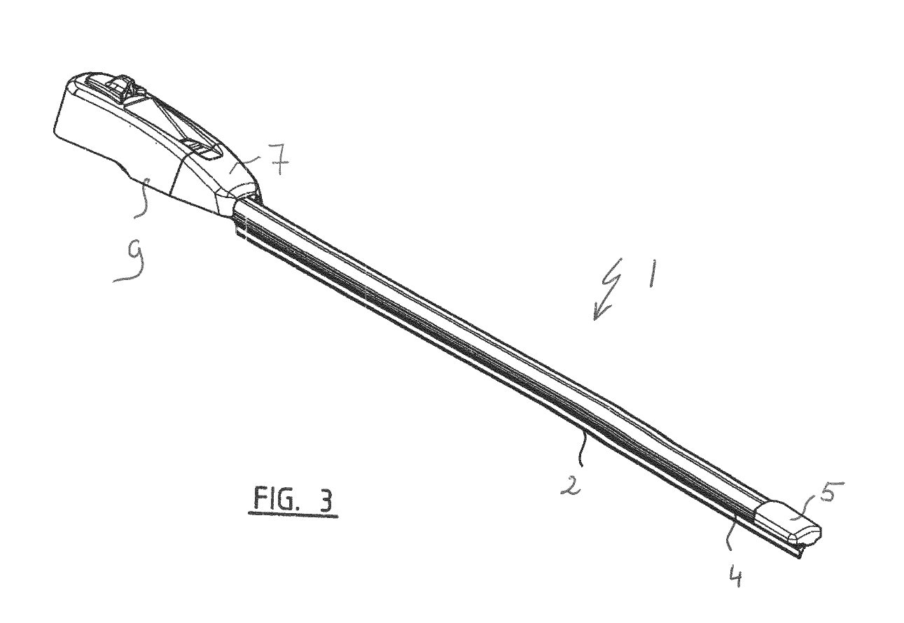

FIG. 3 relates to a perspective and schematic view of a windscreen wiper device according to the invention;

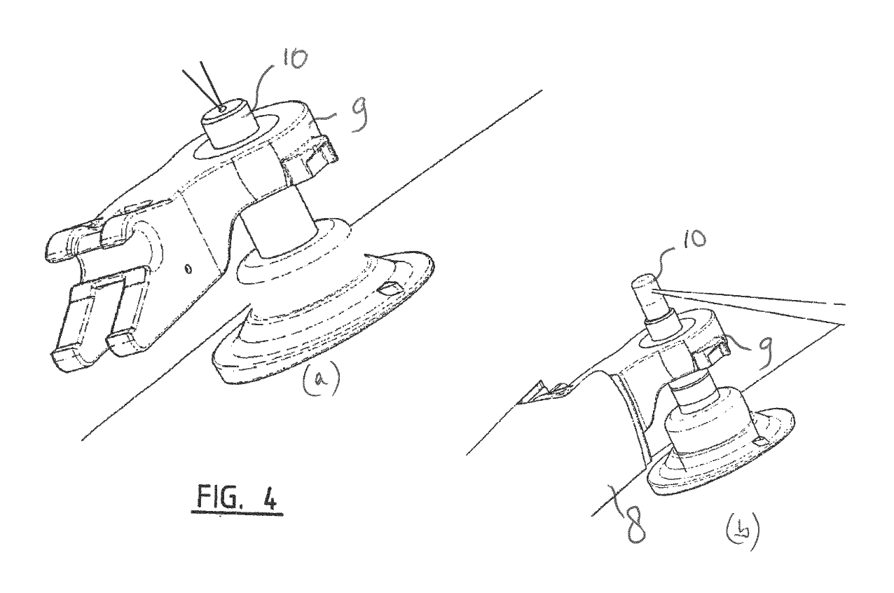

FIG. 4 shows a perspective and schematic view of a mounting head on a drive shaft spraying a liquid jet in the windscreen wiper device of FIG. 3 and in the windscreen wiper device (referring to the present invention) of FIG. 2 (relating to the prior art);

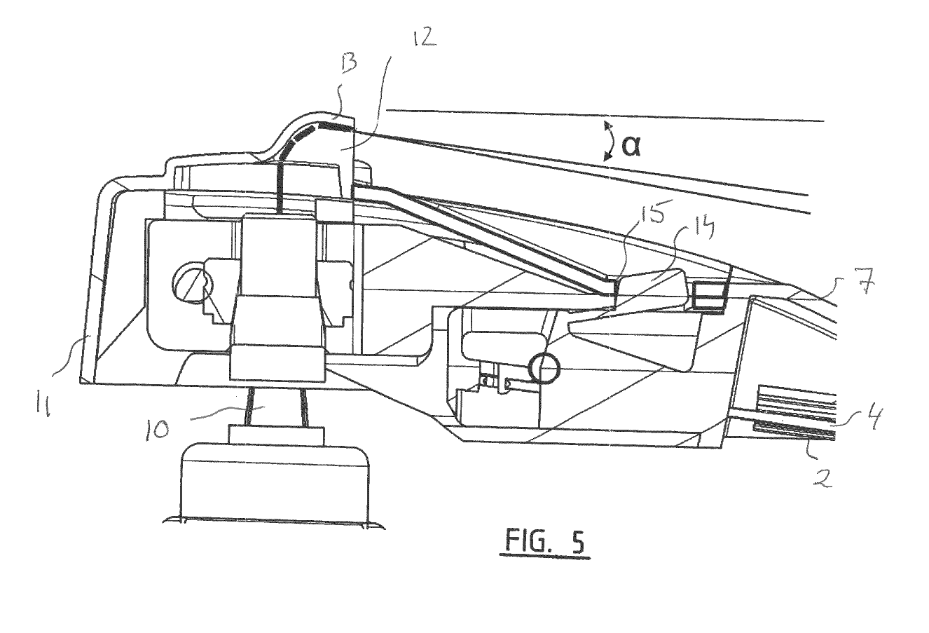

FIG. 5 depicts schematic cross-sectional view of the windscreen wiper device of FIG. 3 at the location of a mounting on a drive shaft thereof; and

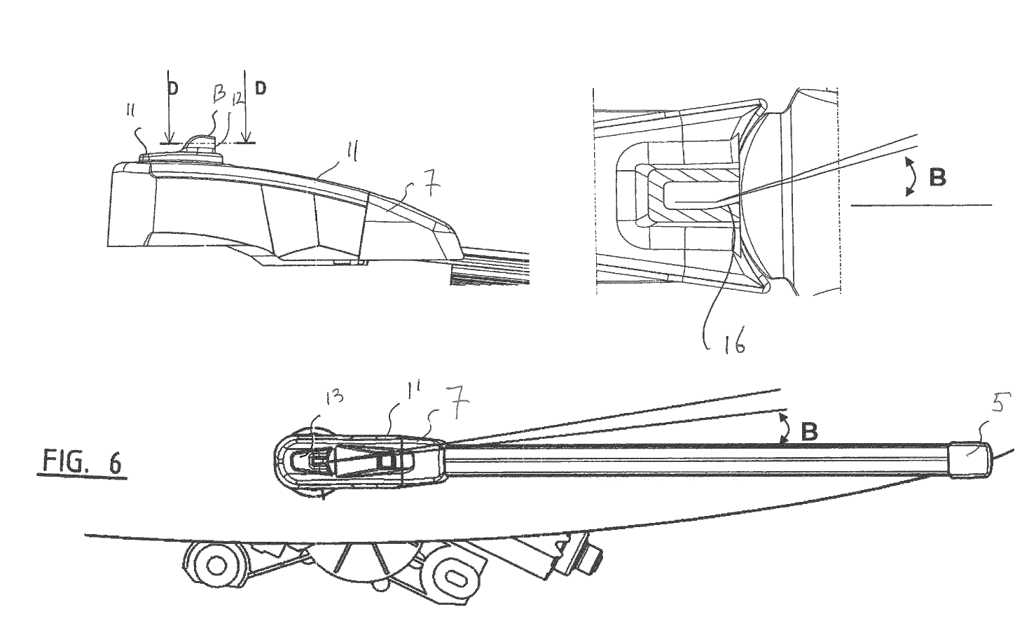

FIG. 6 is a top view, partly in cross-section, of the windscreen wiper device of FIG. 3.

### DETAILED DESCRIPTION

With reference to FIGS. 1 and 2 relating to the prior art a windscreen wiper device 1 of a so-called “flat blade” type is shown. the windscreen wiper device 1 is built up of an elastomeric wiper blade 2, in the longitudinal sides of which opposing longitudinal grooves 3 are formed, and of longitudinal strips 4 made of spring band steel, which are fitted in the longitudinal grooves 3. the strips 4 form a flexible carrier element for the wiper blade 2, as it were, which is thus biased in a curved position (the curvature in operative position being that of a windscreen to be wiped). Neighboring ends 5 of the strips 4 at one end of the wiper blade 2 are interconnected by means of a connecting piece 6 or “end cap” functioning as clamping member. In this embodiment, the connecting piece 6 is a separate constructional element, which may be form-locked (“positive locking” or “having a positive fit”) or force-locked to the the connecting piece 6 is in one piece with the strips 4 made of spring band steel. In the latter case the connecting piece 6 forms a transverse bridge for the strips 4, as it were.

The windscreen wiper device 1 is furthermore built up of a connecting device 7 of plastic material for an oscillating 8. Alternatively, the connecting device 7 may also be made of metal, such as steel or aluminum. The connecting device 7 may comprise clamping members that are integral therewith, which engage around longitudinal sides of the strips 4 that face away from each other, as a result of which the connecting device 7 is firmly attached to the unit consisting of the wiper blade 2 and the strips 4. The oscillating arm is pivotally connected to the wiper blade 2.

As illustrated in FIGS. 1 and 2, the windscreen wiper device 1 according to the prior art comprises a plastic or metallic mounting head 9 which can be fixed for rotation to a shaft 10 driven, via a mechanism not illustrated, by a small motor. In use, the shaft 10 rotates alternately in a clockwise and in a counter-clockwise sense carrying the mounting head 9 into rotation also, which in turn draws the oscillating arm 8 in rotation and thereby moves the wiper blade 2.

The windscreen wiper device 1 further comprises a plastic or metallic cap or cover 11 with an opening 12 being connected to the mounting head 9 at the location where the oscillating arm 8 is connected to the mounting head 9.

In a midway position of the wiper blade 2 the drive shaft 10 is arranged to spray a jet of washing liquid laterally outwardly through the opening 12 of the cap 11 onto a windscreen to be wiped.

FIG. 3 relates to a perspective and schematic view of a windscreen wiper device according to a preferred embodiment of the invention, wherein corresponding parts have been designated with the same reference numerals. Please note that in the preferred embodiment no use is made of an intermediate oscillating arm, but the connecting device 7 is directly connected to the mounting head 9 with the help of a so-called bayonet connection.

As shown in FIG. 4a, the drive shaft 10 in the windscreen wiper device 1 according to the invention is arranged to spray a washing liquid in axial direction thereof instead of in lateral outward direction according to the prior art (FIG. 4b).

As depicted in FIG. 5 the liquid leaving the shaft 10 in axial direction thereof is sprayed onto an internal guiding surface 13 of the cap 11 in order to guide the liquid along the guiding surface 13 through the opening 12 of the cap 11 onto a windscreen to be wiped.

The connecting device 7 with the wiper blade 2 is mounted onto the mounting head 9 as follows. During a sliding movement of the connecting device 7 onto the mounting head 9 the resilient tongue in the connecting device 7 is initially pushed in against a spring force and then allowed to spring back into a hole 15 in the mounting head 9, thus snapping, that is clipping the resilient tongue 14 into the hole 15 of the mounting head 9. This is a so-called bayonet-connection. By subsequently pushing in again the resilient tongue 19 against the spring force (as if it were a push button), the connecting device 7 together with the wiper blade 2 may be released from the mounting head 9. Dismounting the connecting device 7 with the wiper blade 2 from the mounting head 9 is thus realized by sliding the connecting device 7 together with the wiper blade 2 in a direction away from the mounting head 9.

With reference to FIG. 6 the guide surface (13) is part of a side surface (16) of the cap (4) so as to allow the liquid to exit the opening (12) of the cap (4) under an angle β relative to the drive shaft (10) and parallel to the wiper blade (2).

The invention is not limited to the embodiments shown, but extends also to other preferred variants falling within the scope of the appended claim.

1. A windscreen wiper device, comprising an elongated wiper blade of a flexible material, which can be placed in abutment with a windscreen to be wiped, said wiper blade comprising a connecting device for an oscillating arm, wherein said oscillating arm near one end thereof is pivotally connected to said wiper blade and near the other end thereof is connected to a mounting head on a drive shaft for transferring a reciprocal movement to said wiper blade, wherein said windscreen wiper device further comprises a cap connected to said mounting head at the location where said oscillating arm is connected to said mounting head, wherein said drive shaft is arranged to spray a liquid under pressure through an opening of said cap onto a windscreen to be wiped, wherein said drive shaft is arranged to spray said liquid in axial direction thereof onto an internal guiding surface of said cap in order to guide said liquid along said guiding surface through said opening of said cap onto a windscreen to be wiped.

2. The windscreen wiper device according to claim 1, wherein said guiding surface is part of a top surface of said cap.

3. A windscreen wiper device according to claim 2, wherein said top surface has a curved shape so as to allow said liquid to exit said opening of said cap under an angle a with the drive shaft and towards a windscreen to be wiped.

4. The windscreen wiper device according to claim 3, wherein an end portion of said curved shape encloses the angle a with the drive shaft.

5. The windscreen wiper device according to claim 3 wherein said angle a lies with the range of 10-30°.

6. The windscreen wiper device according to claim 1, wherein said guiding surface is part of side surface of said cap.

7. The windscreen wiper device according to claim 6, wherein said side surface has a curved shape so as to allow said liquid to exit said opening of said cap under an angle β with the drive shaft and parallel to said wiper blade.

8. The windscreen wiper device according to claim 3, wherein an end portion of said curved shape encloses an angle β with the drive shaft.

9. The windscreen wiper device according to claim 8 wherein said angle β lies with the range of 10-30°.

10. The windscreen wiper device according to claim 1, wherein said windscreen wiper device is arranged to be used on a rear windscreen.

11. A drive shaft to be used in a windshield wiper device according to claim 1.

12. A cap to be used in a windshield wiper device according to claim 1.
